(19) United States
(12) Patent Application Publication
(10) Pub. No.: US 2005/0189514 A1
(43) Pub. Date: Sep. 1, 2005

(54) Liquid crystal materials having silyl tail groups

(76) Inventors: William Thurmes, Longmont, CO (US); Kundalika More, Denver, CO (US); Neil Gough, Longmont, CO (US); Rohini Vohra, Boulder, CO (US); Michael Wand, Boulder, CO (US); Deven Parghi, Boulder, CO (US)

Correspondence Address: GREENLEE WINNER AND SULLIVAN P C, 4875 PEARL EAST CIRCLE, SUITE 200, BOULDER, CO, 80301, US

(21) Appl. No.: 11/057,402

(22) Filed: Feb. 11, 2005

Related U.S. Application Data
(60) Provisional application No. 60/543,624, filed on Feb. 11, 2004.

(51) Int. Cl. C09K 19/52; C09K 19/54; C09K 19/34

(52) U.S. Cl. 252/299.01; 252/299.5; 428/1.1; 252/299.61

(57) ABSTRACT

Provided are additive liquid crystalline compounds that, when added to one or more other components, form a mixture which can be supercooled. One class of additive liquid crystalline compounds are silyl-containing liquid crystalline compounds. Also provided are devices incorporating one or more silyl-containing liquid crystalline compounds described herein and optionally one or more other components. The invention also includes the method of using liquid crystalline mixtures containing silyl-containing liquid crystalline compounds to suppress the crystallization, in a liquid crystal cell, of these mixtures at temperatures below their crystallization point.

### CROSS-REFERENCE TO RELATED APPLICATIONS

This application claims the benefit of U.S. Provisional Application No. 60/543,624, filed Feb. 11, 2004, which is incorporated by reference.

### BACKGROUND OF THE INVENTION

Low temperature stability of mixtures of liquid crystal compounds is a useful property. Devices containing liquid crystal mixtures are more robust if the mixtures can survive without crystallizing for some time at a low temperature. There is a need in the art for liquid crystal mixtures that can be supercooled.

### SUMMARY OF THE INVENTION

Provided are additive liquid crystalline compounds that, when added to one or more other components, form a mixture which can be supercooled. One class of additive liquid crystalline compounds are silyl-containing liquid crystalline compounds as further described herein. In addition, mixtures of compounds containing one or more silyl-containing liquid crystalline compounds described herein and one or more other liquid crystal compounds are provided. In one embodiment, these mixtures can be supercooled. Also provided are devices incorporating one or more silyl-containing liquid crystalline compounds described herein and optionally one or more other components. The invention includes methods of increasing the low temperature stability of a mixture. In one example, methods of increasing the low temperature stability of a mixture comprise adding one or more silyl-containing liquid crystalline compounds described herein to the mixture. The invention also includes the method of using liquid crystalline mixtures containing silyl-containing liquid crystalline compounds to suppress the crystallization, in a liquid crystal cell, of these mixtures at temperatures below their crystallization point. The invention also includes the method of using one or more silyl-containing liquid crystalline compounds of the invention in a mixture, to provide low temperature stabilization. Methods of making mixtures and devices are known to one of the ordinary skill in the art.

One class of silyl-containing liquid crystalline compounds of the invention are given by formula (I): 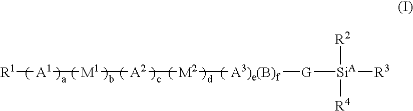
wherein:
R¹ is a straight-chain or branched alkyl or alkenyl group (with or without one or more asymmetrical carbon atoms) containing 2 to 16 carbon atoms, wherein one or two non-adjacent —CH2— groups may be substituted by —O—, —S—, —CO—O—, or —O—CO— and wherein one or more hydrogens may be replaced by fluorine;
A¹, A², A³ may be the same or different and are selected from the group consisting of: 1,4-phenylene, naphth-2,6-diyl, 1,4-dihydronaphth-2,6-diyl, 1,2,3,4-tetrahydronaphth-2,6-diyl, trans-1,4-cyclohexylene, 1,4-cyclohexyl, 1,2-cyclohexen-1,4-diyl, pyridine-2,5-diyl, pyrimidine-2,5-diyl, 1,3,4-thisdiazol-2,5-diyl, pyrazine-2,5-diyl, pyridizine-3,6-diyl, 1,3-dithiane-2,5-diyl, 1,3-dioxane-2,5-diyl, and thiophen-2,5-diyl, wherein independently in each of the groups A¹, A² and A³, one or two hydrogens may be replaced by fluorine or methyl;
M¹, M² may be the same or different and are selected from the group consisting of: —CO—, —O—CO—, —CH2—O—, —CH2—CH2—, —CH═CH—, —C≡C—, and —O—CH2—;
G is a single bond or a straight-chain alkylene or alkenylene group containing 1 to 16 carbon atoms in which one or two nonadjacent —CH2— groups may be replaced by —O—, —CO—O—, or —O—CO—; provided that Si^{A} is bound only to a carbon atom in G;
R², R³, R⁴ may be the same or different and are straight-chain or branched-chain alkyl or alkenyl groups, or a cycloalkane or cycloalkene, containing 1 to 16 carbon atoms, in which one to three nonadjacent —CH2— groups may be replaced by —O—, —CO—O—, —O—CO—, —Si(Me2)—, with the proviso that the Si in —Si(Me2)— is bound only to a carbon atom, and any or all of the hydrogen atoms on the carbons may be substituted with fluorines;
B is —O—, —S—, —CO—O—, or —O—CO—, —CO—, —S—CO—, —CO—S—, or a single bond;
a,b,c,d,e,f=0 or 1, provided that a+c+e=1, 2 or 3.

In Formula (I), the grouping
(-A¹)ₐ(-M¹)_{b}(-A²)_{c}(-M²)_{d}(-A³)ₑ-
is designated the core. Some examples of cores include: 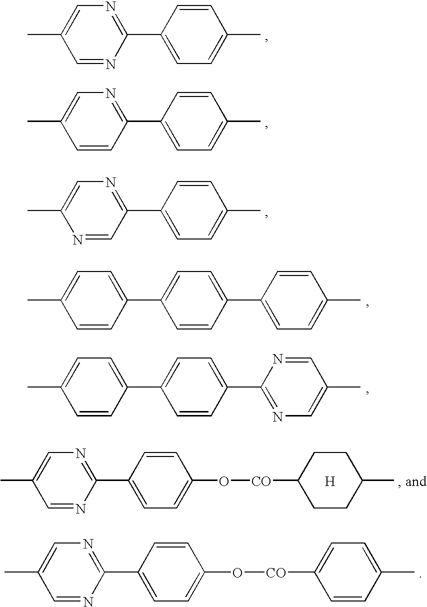
Other cores that are included in the invention include those in Scheme 1:

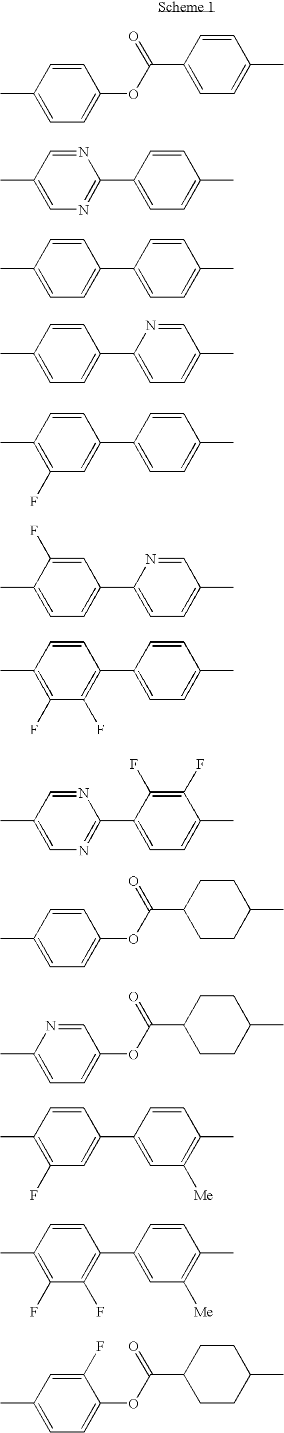

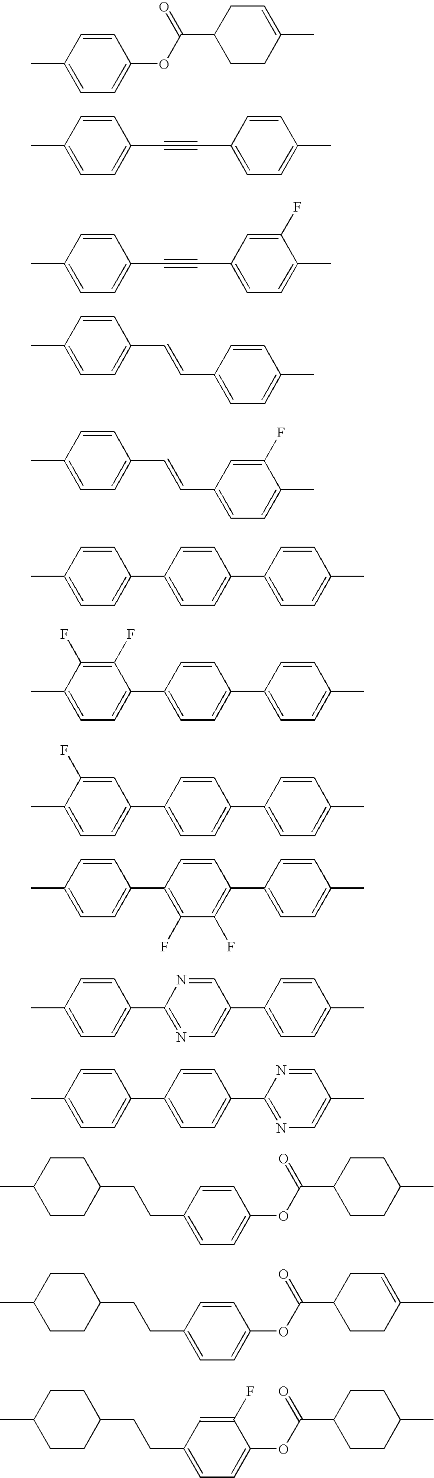

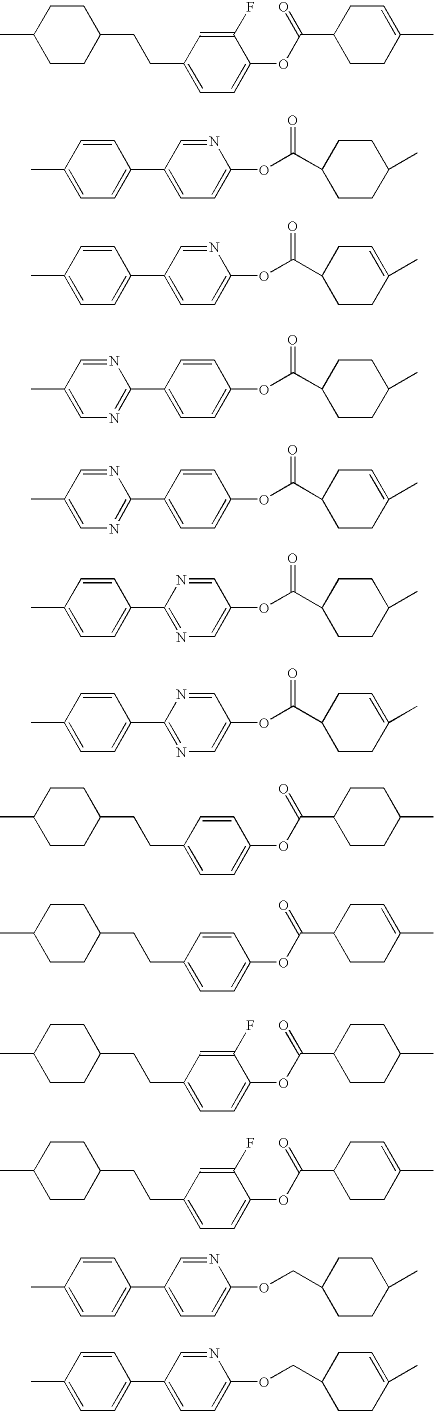

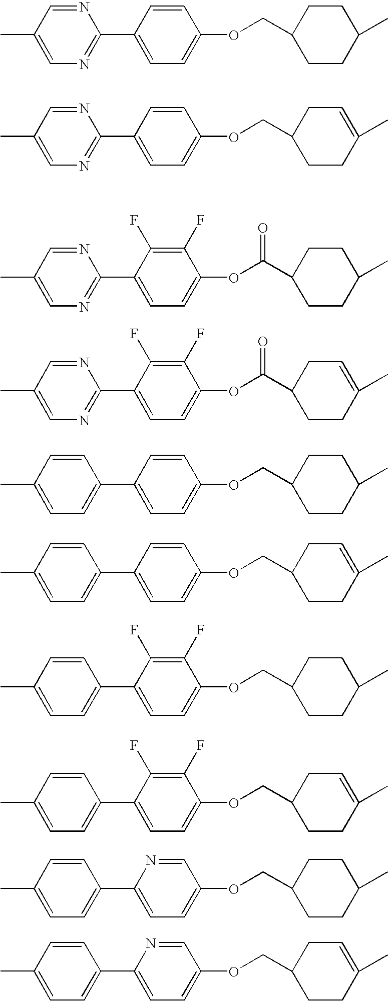

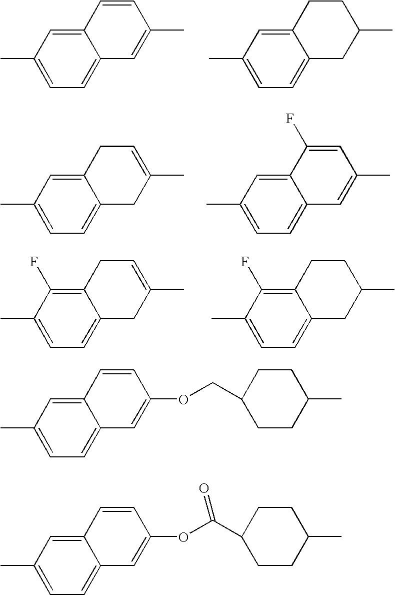

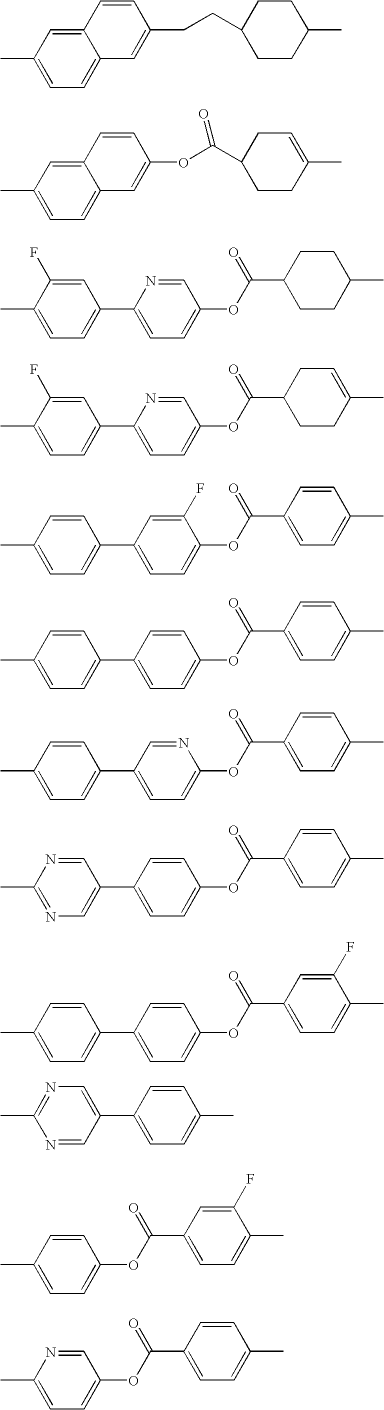

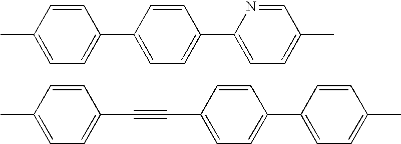

One class of compounds of the invention includes those compounds where G is a single bond and f is 0, so that the core and Si^{A} are directly attached.

Specific classes of silyl-containing liquid crystalline compounds of the invention are those containing a trimethylsilylalkyl tail directly attached to an aryl core, liquid crystalline compounds containing a trimethylsilylalkyl tail either directly attached to a terphenyl core or attached via an ether linkage, and liquid crystalline compounds containing a silyl-containing tail wherein one or more of the functional groups in the silyl-containing tail contains either an alkene group or a branched group.

One class of silyl-containing liquid crystalline compounds of the invention are those having one silyl-containing tail group, one tail group not containing a silyl group, and a core. One class of silyl-containing liquid crystalline compounds of the invention are those where the silyl-containing tail contains either a branched alkyl chain or an alkene group (silylalkyl or silylalkenyl compounds). Specific examples of this type of compound are given in examples 1 through 9. Silyl-containing liquid crystalline compounds of the invention are effective at low temperature stabilization of mixtures, and increasing the A-C transition temperature of mixtures without sacrificing low temperature switching speed. These parameters are known in the art. Adding silyl-containing liquid crystalline compounds of the invention above about 2 mole percent gives the desired low temperature stability to a mixture of liquid crystal compounds. The amount of silyl-containing liquid crystalline compounds used in a mixture is determined by a variety of factors, including the desired degree of low temperature stabilization. The low temperature stability can be easily measured by methods described herein and known to one of ordinary skill in the art. There is no upper limit of the amount of silyl-containing crystalline compounds of the invention that can be used, subject to the desired characteristics of the mixture, as determined by one of ordinary skill in the art. Particular ranges of the amount of silyl-containing liquid crystalline compounds used in a mixture are all intermediate ranges above about 2 mole percent.

Some examples of non-silyl tails of the compounds of the invention are described in the examples and the references disclosed herein, which are incorporated by reference to the extent not inconsistent with the disclosure herewith.

When a group of substituents is disclosed herein, it is understood that all individual members of those groups and all subgroups and classes of compounds that can be formed using the substituents are disclosed separately.

### DETAILED DESCRIPTION OF THE INVENTION

The invention may be further understood by reference to the following non-limiting examples and description.

Including silyl groups in liquid crystalline compounds surprisingly increases the low temperature stability of the liquid crystalline compounds and mixtures containing one or more of the silyl-containing liquid crystalline compounds. Specifically, an increase in low temperature stability means that mixtures containing one or more silyl-containing liquid crystalline compounds can survive without crystallizing for a longer time at low temperatures, often below their crystallization temperature (i.e., in a supercooled state) than mixtures that do not contain silyl-containing liquid crystalline compounds. Liquid crystal cells containing small amounts of silyl-containing liquid crystalline compounds have a reduced propensity towards crystallization so that the cells can survive for a longer time (in some cases many days) at several different temperatures below the crystallization temperature of the liquid crystal than cells not containing silyl-containing liquid crystalline compounds. “Small amounts” means at least an amount to provide a measurable effect. Typically, small amounts mean at least about 2 mole percent. All individual values and ranges in values from the lowest percent of silyl-containing liquid crystalline compounds up to the highest percent of silyl-containing liquid crystalline compounds that gives the desired properties are included herein. In one particular example, small amounts of silyl-containing liquid crystalline compounds can survive over ten days at temperatures 5, 10, 15, and 20° C. below the crystallization temperature of the liquid crystal. As a practical testing matter, cells will sometimes be able to withstand lower temperatures, e.g., −35° C., without crystallization, yet crystallize at higher temperatures, e.g., −30° C., so the crystallization tendency must be tested at several temperatures.

Also, silyl-containing liquid crystalline compounds of the invention and mixtures containing one or more silyl-containing liquid crystalline compounds of the invention show higher smectic C stability and lower viscosity than similar compounds lacking the silyl group and mixtures not containing silyl-containing liquid crystalline compounds. In particular, when the viscosities of liquid crystal mixtures are measured at temperatures lower than room temperature, mixtures containing one or more silyl-containing liquid crystalline compounds of the invention have lower viscosities than those of mixtures not containing silyl-containing liquid crystalline compounds. These properties are useful in creating mixtures with higher A-C transitions while retaining acceptably fast switching speeds at temperatures below 0° C.

In the following example liquid crystalline compounds, the phase map is measured optically on a microscope equipped with a calibrated hotstage, as known in the art. The phase temperatures between the phases
Isotropic (I)
Nematic (N or N*)
Smectic C (S_{C} or S_{C}*)
Smectic A (S_{A} or S_{A}*)
Smectic G (S_{G} or S_{G}*) and
Crystalline (Cr)
   are specified in ° C., and the values are placed between the phase denotations in the phase example.

### EXAMPLE 1

### DTC1560

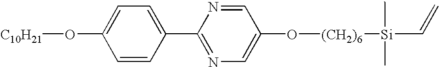

### 2-(4-Decyloxy-phenyl)-5-[6-(dimethylvinylsilanyl)-hexyloxy]-pyrimidine

### EXAMPLE 2

### DTC1561

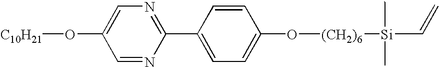

### 5-Decyl-2-{4-[6-(dimethylvinylsilanyl)-hexyloxy]-phenyl}-pyrimidine

### EXAMPLE 3

### DTC2040

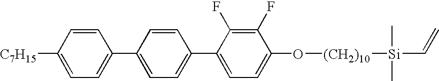

### [10-(2,3-Difluoro-4″-heptyl-[1,1′;4′, 1″]terphenyl-4-yloxy)-decyl]-dimethylvinylsilane I 1134.5 S_{C} 57 S_{G} 40 Cr

### EXAMPLE 4

### DTC2050

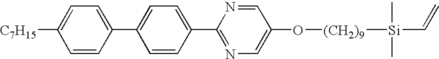

### 5-[9-(Dimethyl-vinyl-silanyl)-nonyloxy]-2-(4′-heptyl-biphenyl-4-yl)-pyrimidine Cr 74 S_{C} 149.7 I

### EXAMPLE 5

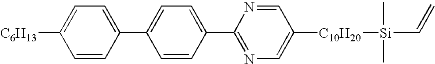

### 5-[10-(Dimethyl-vinyl-silanyl)-decyl]-2-(4′-hexyl-biphenyl-4-yl)-pyrimidine Cr 52 S_{C} 125.4 I

### EXAMPLE 6

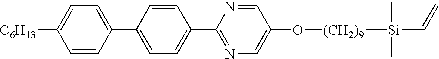

### 5-[9-(Dimethyl-vinyl-silanyl)-nonyl]-2-(4′-hexyl-biphenyl-4-yl)-pyrimidine Cr 56 S_{C} 117.4 I

### EXAMPLE 7

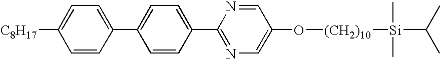

### 5-[10-(Isopropyl-dimethyl-silanyl)-decyl]-2-(4′-octyl-biphenyl-4-yl)-pyrimidine Cr 77 I

### EXAMPLE 8

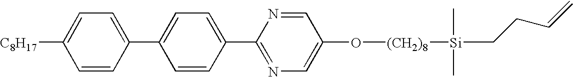

### 5-[8-(But-3-enyl-dimethyl-silanyl)-octyloxy]-2-(4′-octyl-biphenyl-4-yl)-pyrimidine

### EXAMPLE 9

### DTC1740

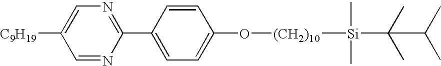

### 2-(4-{10-[dimethyl-(1,1,2-trimethyl-propyl)-silanyl]-decyloxy}-phenyl)-5-nonyl-pyrimidine

### EXAMPLE 10

### DTC1701

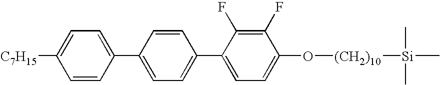

### [10-(2″,3″-difluoro-4-heptyl-[1,1′;4′,1″]terphenyl-4″-yloxy)-decyl]-trimethylsilane

### EXAMPLE 11

### DTC1977

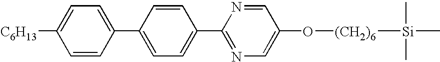

### 2-(4′-hexylbiphenyl-4-yl)-5-[6-(trimethylsilanyl)-hexyl]-pyrimidine

### EXAMPLE 12

### DTC2145

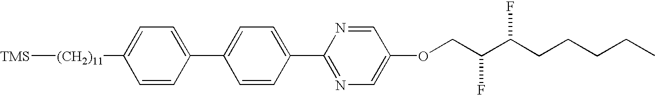

### 5-(2,3-difluorooctyloxy)-2-[4′-(11-trimethylsilanylundecyl)-biphenyl-4-yl]-pyrimidine

### EXAMPLE 13

### DTC2116

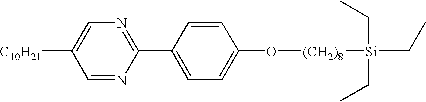

### 5-decyl-2-[4-(8-triethylsilanyloctyloxy)-phenyl]-pyrimidine

### EXAMPLE 14

### DTC2117

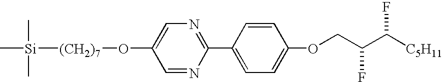

### 2-[4-[(2R,3R)-2,3-difluorooctyloxy]-phenyl]-5-(7-trimethylsilanylheptyloxy)-pyrimidine

### EXAMPLE 15

### DTC2118

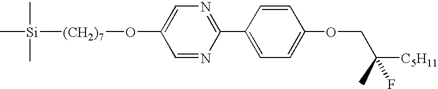

### 2-[4-[(2S)-2-fluoro-2-methylheptyloxy]-phenyl]-5-(7-trimethylsilanylheptyloxy)-pyrimidine

### EXAMPLE 16

### DTC2033

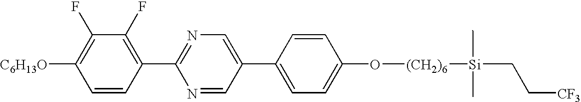

### 2-(2,3-difluoro-4-hexyloxyphenyl)-5-(4-{6-[dimethyl-(3,3,3-trifluoropropyl)-silanyl]-hexyloxy}-phenyl)-pyrimidine

### EXAMPLE 17

### DTC1917

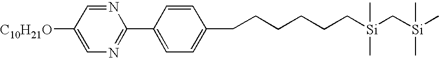

### 5-decyloxy-2-{4-[6-(dimethyltrimethylsilanylmethylsilanyl)-hexyl]-phenyl}-pyrimidine

### EXAMPLE 18

### DTC1981

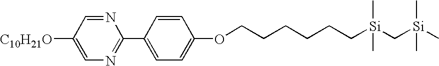

### 5-decyl-2-{4-[6-(dimethyltrimethylsilanylmethylsilanyl)-hexyloxy]-phenyl}-pyrimidine

### EXAMPLE 19

### DTC1840

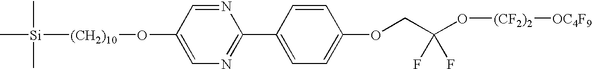

### 2-{4-[2,2-Difluoro-2-(1,1,2,2-tetrafluoro-2-nonafluorobutyloxyethoxy)-ethoxy]-phenyl}-5-(10-trimethylsilanyldecyloxy)-pyrimidine

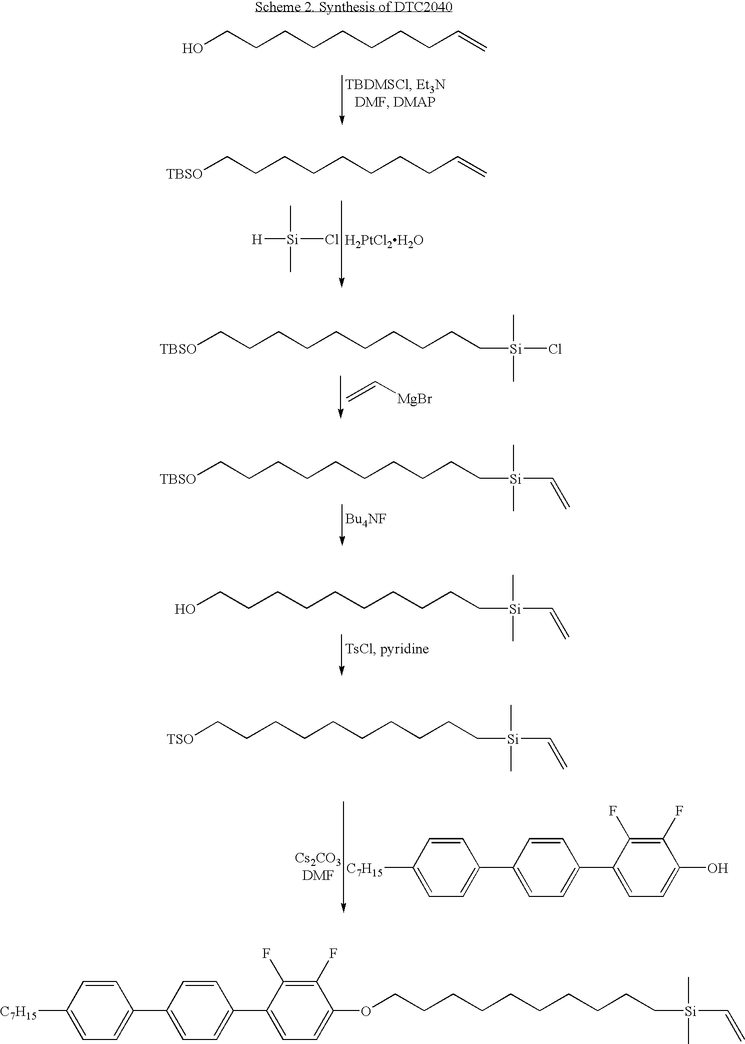

Compounds of the invention and mixtures of the invention may be prepared using methods disclosed herein and those known to one of ordinary skill in the art. Methods of synthesizing certain compounds and components of compounds of the invention are known in the art and are described in U.S. Pat. Nos. 5,106,530; 5,158,702; 5,188,762; 5,210,247; 5,277,838; 5,348,684; 5,399, 290; 5,106,530; 6,413,448; and EP 0549347, all of which are incorporated by reference to the extent not inconsistent with the disclosure herewith. The patents referenced herein also provide further examples of cores.

Silyl-containing liquid crystalline compounds with oxygen linkages between the silyl-containing tail and the aromatic core are made by the method outlined in Scheme 2 and described below, and slight variations thereof, known to one of ordinary skill in the art:

To a solution of 28 mmoles 9-decenol and 31 mmoles tert-butyldimethylsilyl chloride in 7 mL dimethylformamide was added 56 mmoles triethylamine and 2.8 mmoles dimethylformamide. The reaction was allowed to proceed for 24 hours, at which time 20 mL water were added, and was then extracted into hexane. The combined organic layers were extracted with a 1N HCl solution, then with brine, then concentrated in vacuo. The material was filtered through 70 g silica gel, eluting with hexane, and concentrated in vacuo to give 6.78 g tert-butyl-dec-9-enyloxy-dimethyl-silane as a clear oil.

To a high-pressure glass tube was added 7.4 mmoles tert-butyl-dec-9-enyloxy-dimethyl-silane, 102 mmoles chlorodimethylsilane, and 0.02 mmoles hydrogen hexachloroplatinate (IV) hydrate. The tube was heated 18 hours at 101° C., then cooled to room temperature, and concentrated in vacuo. The resultant chlorosilane was then added to 22 mL of tetrahydrofuran, the solution was cooled to −70° C., and 10 ml of a 1M solution of vinylmagnesium bromide was added. It was allowed to stir at −70° C. for 1.5 hours, then slowly warmed to room temperature. The reaction was neutralized with pH 7 buffer, and extracted with a hexane-ethyl acetate mixture, and concentrated in vacuo. The material was chromatographed using silica gel and 19:1 hexane:ethyl acetate, and concentrated in vacuo, to yield 1.56 g {[10-(tert-butyldimethylsilanyloxy)-decyl]-dimethylsilanyl}-ethene.

To a solution of 4.28 mmoles {[110-(tert-butyldimethylsilanyloxy)-decyl]-dimethylsilanyl}-ethene in 13 ml tetrahydrofuran is added 4.3 ml of a 1 M tetrabutylammonium fluoride in tetrahydrofuran solution. The reaction was allowed to stir for 1 hour, 30 ml water was added, and the reaction was extracted into a hexane-ethyl acetate solution. The combined organics were washed with brine, dried with sodium sulfate, and concentrated in vacuo. The resultant oil was chromatographed with silica gel, eluting with 4:1 hexane:ethyl acetate. This yielded 0.82 g of 110-(dimethylvinylsilanyl)-decan-1-ol.

To a solution of 3.4 mmoles 10-(dimethylvinylsilanyl)-decan-1-ol in 1.4 ml pyridine, cooled to 0° C., was added 3.57 mmoles toluenesulfonyl chloride. The reaction was allowed to stir for 2 hours, and was then left unstirred at −20° C. for 18 hours. It was then stirred, and placed at 5° C. for 5 hours. The reaction was then filtered and washed with tetrahydrofuran, ammonia was added to destroy any unreacted toluenesulfonyl chloride, and the reaction was quenched with water, which was then extracted with hexane. The combined organic layers were successively washed with 1N HCl and brine, then dried over potassium carbonate and concentrated in vacuo. The resultant oil was chromatographed over silica gel, eluting with 19:1 hexane:ethyl acetate, and concentrated in vacuo, to yield 1.22 g toluene-4-sulfonic acid 10-(dimethylvinylsilanyl)-decyl ester.

To a flask containing 0.53 mmoles toluene-4-sulfonic acid 10-(dimethylvinylsilanyl)-decyl ester, 0.53 mmoles 2,3-difluoro-4″-heptyl-[1,1′;4′,1″]terphenyl-4-ol, and 0.58 mmoles cesium carbonate was added 5.3 ml dimethylformamide. The reaction was allowed to stir overnight, and was then heated to 100° C. for 1 hour. After cooling, the reaction mixture was poured into 20 ml water and extracted into a 1:1 mixture of hexane and ethyl acetate. The combined organic layers were washed with brine and dried over magnesium sulfate, then concentrated in vacuo, The product was then chromatographed with silica gel using a 89:10:1 hexane:dichloromethane:ethyl acetate mixture as an eluent. After concentrating the clean fractions in vacuo, the white solid was recrystallized from a 65:35 mixture of acetonitrile:ethyl acetate to yield 0.19 g [10-(2,3-difluoro-4″-heptyl-[1,1′;4′,1″]terphenyl-4-yloxy)-decyl]-dimethyl-vinyl-silane.

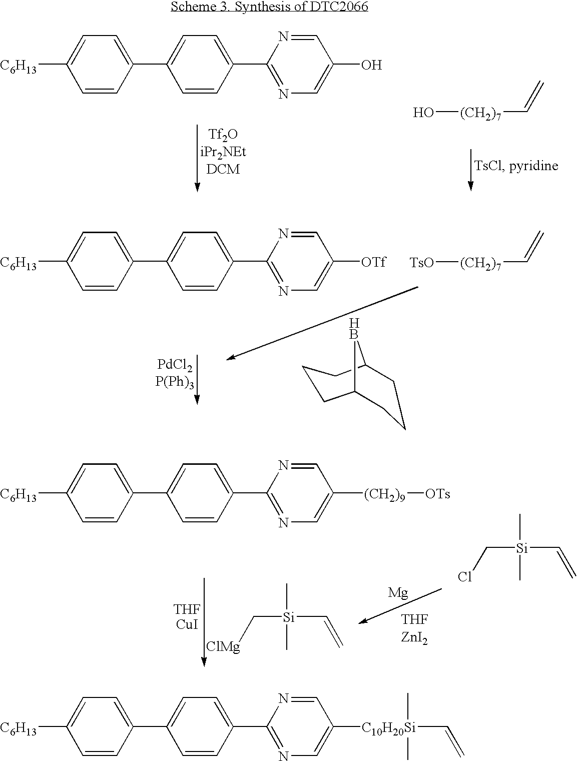

Silyl compounds without oxygen linkages between the silyl-containing tail and the aromatic core are made by the method outlined in Scheme 3 and described below, and slight variations thereof, known to one of ordinary skill in the art.

To a solution of 3 mmoles 2-(4′-hexylbiphenyl-4-yl)-pyrimidin-5-ol and 3 mmoles N-phenyltrifluoromethanesulfonimide in 30 ml tetrahydrofuran, cooled to −70° C., was added 0.63 ml triethylamine. The reaction was allowed to stir for 1 hour, then gradually warmed to room temperature and allowed to stir for 12 hours. The reaction mixture was concentrated in vacuo, filtered through silica gel, eluting with 19:1 hexane:ethyl acetate, and concentrated in vacuo, to yield 0.93 g of trifluoromethanesulfonic acid 2-(4′-hexyl-biphenyl-4-yl)-pyrimidin-5-yl ester.

To a solution of 20 mmoles 8-nonen-1-ol in 5 ml pyridine, cooled to 0° C., was added 22 mmoles toluenesulfonyl chloride. The reaction was allowed to stir for 2 hours, and was then left unstirred at −20° C. for 18 hours. It was then stirred, and placed at 5° C. for 5 hours. The reaction was then filtered and washed with tetrahydrofuran, ammonia was added to destroy any unreacted toluenesulfonyl chloride, and the reaction was quenched with water, which was then extracted with hexane. The combined organic layers were successively washed with 1N HCl and brine, then dried over potassium carbonate and concentrated in vacuo. The resultant oil was chromatographed over silica gel, eluting with 19:1 hexane:ethyl acetate, and concentrated in vacuo, to yield 4.82 g toluene-4-sulfonic acid non-8-enyl ester.

To 3.23 mmoles toluene-4-sulfonic acid non-8-enyl ester in a flask, cooled to 0° C., is added 6.47 ml of a solution of 9-BBN in tetrahydrofuran. The reaction is allowed to stir 2 hours, then left at 5° C. for 18 hours. The reaction is cooled again to 0° C., and 3.25 mmoles sodium hydroxide and 0.09 mmoles dichlorobis(triphenylphosphine)palladium(II) were added. The reaction was stirred a further 5 minutes, at which time 2.16 mmoles trifluoromethanesulfonic acid 2-(4′-hexyl-biphenyl-4-yl)-pyrimidin-5-yl ester in 5 ml tetrahydrofuran were added to the mixture. The reaction mixture was heated to 60° C., and allowed to stir at that temperature for two hours. The reaction mixture was cooled to room temperature, poured into water, and extracted with a hexane/ethyl acetate mixture. The combined organic layers were washed with brine, dried over magnesium sulfate, and concentrated in vacuo. It was recrystallized from acetonitrile to give 0.98 g of toluene-4-sulfonic acid 9-[2-(4′-hexylbiphenyl-4-yl)-pyrimidin-5-yl]-nonyl ester.

To a dried flask containing 150 mmoles mmoles magnesium was added 10 ml tetrahydrofuran. After 30 minutes stirring, the stir plate was turned off and 0.26 ml dibromoethane was added to the reaction mixture. When the solution had finished bubbling rapidly, 3 mmoles dried zinc chloride were added. Then a solution of 100 mmoles vinylchloromethyldimethylsilane in 90 ml tetrahydrofuran were slowly added. When the reaction had cooled, the next reaction was started. To a solution of 26.9 mmoles toluene-4-sulfonic acid 9-[2-(4′-hexylbiphenyl-4-yl)-pyrimidin-5-yl]-nonyl ester and 1.35 mmoles cuprous chloride in 80 ml tetrahydrofuran, cooled to 0° C., was added the Grignard solution. The reaction was allowed to stir at 0° C. for 2 hours, and was then warmed to room temperature and allowed to stir an additional 18 hours. The reaction mixture was quenched with a dilute aqueous ammonium chloride solution, which was subsequently extracted with a mixture of hexane and ethyl acetate. The combined organics were washed with brine, dried over magnesium sulfate, and concentrated in vacuo. The resultant oil was chromatographed with silica gel, eluting with 19:1 hexane:ethyl acetate. After concentrating the clean fractions in vacuo, the white solid was recrystallized from a 55:45 mixture of acetonitrile:ethyl acetate to yield 13.5 g of 5-[10-(dimethylvinylsilanyl)-decyl]-2-(4′-hexylbiphenyl-4-yl)-pyrimidine.

In the following examples, the phase map is measured on a differential scanning calorimeter, heating at 10° C. per minute. The viscosity and polarization are measured on a commercially available APT (Automated Property Tester, made by Displaytech, Inc.) using commercially available 4 μm cells incorporating a rubbed polyimide layer. The cells are annealed before the viscosity and polarization were measured, as known to one of ordinary skill in the art.

### EXAMPLE |1|

a) A mixture composed of the 11 components

| | | |
|---|---|---|
| 5-[[(2R,3R)-2,3-difluorooctyl]oxy]-2-(4-octylphenyl)- | 7.1 | mol % |
| pyridine | | |
| 5-[[(3S)-3,7-dimethyloctyl]oxy]-2-[4-[[(3S)-3,7- | 1.7 | mol % |
| dimethylocty]oxy]phenyl]-pyrimidine | | |
| heptanoic acid 4-(5-octylpyrimidin-2-yl)-phenyl ester | 18.4 | mol % |
| 4-pentylcyclohexanecarboxylic acid 4-(5-decylpyrimidin- | 10.4 | mol % |
| 2-yl)-phenyl ester | | |
| 2-(4-hexyloxyphenyl)-5-octyloxypyrimidine | 9.5 | mol % |
| 5-octyloxy-2-(4-octyloxyphenyl)-pyrimidine | 8.8 | mol % |
| 2-(4-nonyloxyphenyl)-5-octyloxypyrimidine | 8.5 | mol % |
| 2-(4-dodecyloxyphenyl)-5-octyloxypyrimidine | 7.8 | mol % |
| 2-(4-decyloxyphenyl)-5-octyloxypyrimidine | 8.3 | mol % |
| 5-heptyl-2-(4-octyloxyphenyl)-pyrimidine | 9.5 | mol % |
| 5-[9-(dimethylvinylsilanyl)-nonyloxy]-2-(4′- | 10 | mol % |
| heptylbiphenyl-4-yl)-pyrimidine | | |

Exhibits the following liquid crystalline properties:
Phase map: Cr −8.7 S_{C} 83.6 S_{A} 91.3 N 98.8 I; S_{C} −19.3 Cr
Viscosity at 0° C.: 290 millipascal seconds
Polarization at 0° C.: 38.7 nC/cm²
   b) For a comparison, the liquid crystalline mixture which differs from the above-mentioned mixture only in that it contains no silyl component has the following properties:
Phase map: Cr 0 S_{C} 76.1 S_{A} 84.4 N 93.1 I; S_{C} −14.5 Cr
Viscosity at 0° C.: 474 millipascal seconds
Polarization at 0° C.: 43.5 nC/cm²
The addition of the silane therefore reduced the viscosity of the mixture.
   c) For another comparison, the liquid crystalline mixture which differs from mixture 1a only in that the silyl component is replaced at the same molar concentration with 5-octyloxy-2-{4-[10-(trimethylsilanyl)-decyloxy]-phenyl}-pyrimidine, a silyl component not covered by this patent, has the following properties:
Phase map: Cr −1.8 S_{C} 74.0 S_{A} 85.4 N 92.0 I; S_{C} −14.0 Cr
Viscosity at 0° C.: 250 millipascal seconds
Polarization at 0° C.: 40.6 nC/cm²
   d) For another comparison, the liquid crystalline mixture which differs from mixture 1a only in that the silyl component is replaced at the same molar concentration with 2-(4-hexyloxyphenyl)-5-octyloxypyrimidine, a non-silyl component, has the following properties:
Phase map: Cr 3.1 S_{C} 76.2 S_{A} 84.2 N 92.7 I; S_{C} −13.3 Cr
Viscosity at 0° C.: 181 millipascal seconds
Polarization at 0° C.: 36.6 nC/cm²

### EXAMPLE 2|

a) A mixture composed of the 11 components

| | | |
|---|---|---|
| 5-[[(2R,3R)-2,3-difluorooctyl]oxy]-2-(4-octylphenyl)- | 7.1 | mol % |
| pyridine | | |
| 5-[[(3S)-3,7-dimethyloctyl]oxy]-2-[4-[[(3S)-3,7- | 1.7 | mol % |
| dimethylocty]oxy]phenyl]-pyrimidine | | |
| heptanoic acid 4-(5-octylpyrimidin-2-yl)-phenyl ester | 18.4 | mol % |
| 4-pentylcyclohexanecarboxylic acid 4-(5-decylpyrimidin- | 10.4 | mol % |
| 2-yl)-phenyl ester | | |
| 2-(4-hexyloxyphenyl)-5-octyloxypyrimidine | 9.5 | mol % |
| 5-octyloxy-2-(4-octyloxyphenyl)-pyrimidine | 8.8 | mol % |
| 2-(4-nonyloxyphenyl)-5-octyloxypyrimidine | 8.5 | mol % |
| 2-(4-dodecyloxyphenyl)-5-octyloxypyrimidine | 7.8 | mol % |
| 2-(4-decyloxyphenyl)-5-octyloxypyrimidine | 8.3 | mol % |
| 5-heptyl-2-(4-octyloxyphenyl)-pyrimidine | 9.5 | mol % |
| 5-[10-(isopropyldimethylsilanyl)-decyl]-2-(4′- | 10 | mol % |
| octylbiphenyl-4-yl)-pyrimidine | | |

Exhibits the following liquid crystalline properties:
Phase map: Cr −2.7 S_{C} 60.9 S_{A} 66 N 88.3 I; S_{C} −19.1 Cr
Viscosity at 0° C.: 430 millipascal seconds
Polarization at 0° C.: 33.1 nC/cm²

### EXAMPLE 3|

a) A mixture composed of the 11 components

| | | |
|---|---|---|
| 5-[[(2R,3R)-2,3-difluorooctyl]oxy]-2-(4-octylphenyl)- | 7.1 | mol % |
| pyridine | | |
| 5-[[(3S)-3,7-dimethyloctyl]oxy]-2-[4-[[(3S)-3,7- | 1.7 | mol % |
| dimethylocty]oxy]phenyl]-pyrimidine | | |
| heptanoic acid 4-(5-octylpyrimidin-2-yl)-phenyl ester | 18.4 | mol % |
| 4-pentylcyclohexanecarboxylic acid 4-(5-decylpyrimidin- | 10.4 | mol % |
| 2-yl)-phenyl ester | | |
| 2-(4-hexyloxyphenyl)-5-octyloxypyrimidine | 9.5 | mol % |
| 5-octyloxy-2-(4-octyloxyphenyl)-pyrimidine | 8.8 | mol % |
| 2-(4-nonyloxyphenyl)-5-octyloxypyrimidine | 8.5 | mol % |
| 2-(4-dodecyloxyphenyl)-5-octyloxypyrimidine | 7.8 | mol % |
| 2-(4-decyloxyphenyl)-5-octyloxypyrimidine | 8.3 | mol % |
| 5-heptyl-2-(4-octyloxyphenyl)-pyrimidine | 9.5 | mol % |
| 5-[9-(dimethylvinylsilanyl)-nonyl]-2-(4′- | 10 | mol % |
| hexylbiphenyl-4-yl)-pyrimidine | | |

Exhibits the following liquid crystalline properties:
Phase map: Cr −1.3 S_{C} 80.2 S_{A} 87.6 N 94.2 I; S_{C} −14.0 Cr
Viscosity at 0° C.: 292 millipascal seconds
Polarization at 0° C.: 35.0 nC/cm²

### EXAMPLE 4|

a) A mixture composed of the 11 components

| | | |
|---|---|---|
| 5-[[(2R,3R)-2,3-difluorooctyl]oxy]-2-(4-octylphenyl)- | 7.1 | mol % |
| pyridine | | |
| 5-[[(3S)-3,7-dimethyloctyl]oxy]-2-[4-[[(3S)-3,7- | 1.7 | mol % |
| dimethylocty]oxy]phenyl]-pyrimidine | | |
| heptanoic acid 4-(5-octylpyrimidin-2-yl)-phenyl ester | 18.4 | mol % |
| 4-pentylcyclohexanecarboxylic acid 4-(5-decylpyrimidin- | 10.4 | mol % |
| 2-yl)-phenyl ester | | |
| 2-(4-hexyloxyphenyl)-5-octyloxypyrimidine | 9.5 | mol % |
| 5-octyloxy-2-(4-octyloxyphenyl)-pyrimidine | 8.8 | mol % |
| 2-(4-nonyloxyphenyl)-5-octyloxypyrimidine | 8.5 | mol % |
| 2-(4-dodecyloxyphenyl)-5-octyloxypyrimidine | 7.8 | mol % |
| 2-(4-decyloxyphenyl)-5-octyloxypyrimidine | 8.3 | mol % |
| 5-heptyl-2-(4-octyloxyphenyl)-pyrimidine | 9.5 | mol % |
| 2-(4′-hexylbiphenyl-4-yl)-5-[6-(trimethylsilanyl)-hexyl]- | 10 | mol % |
| pyrimidine | | |

Exhibits the following liquid crystalline properties:
Phase map: Cr −2.0 S_{C} 81.5 S_{A} 88.0 N 94.8 I; S_{C} −18.0 Cr
Viscosity at 0° C.: 278 millipascal seconds
Polarization at 0° C.: 37.7 nC/cm²

### EXAMPLE 5|

a) A mixture composed of the 11 components

| | | |
|---|---|---|
| 5-[[(2R,3R)-2,3-difluorooctyl]oxy]-2-(4-octylphenyl)- | 7.1 | mol % |
| pyridine | | |
| 5-[[(3S)-3,7-dimethyloctyl]oxy]-2-[4-[[(3S)-3,7- | 1.7 | mol % |
| dimethylocty]oxy]phenyl]-pyrimidine | | |
| heptanoic acid 4-(5-octylpyrimidin-2-yl)-phenyl ester | 18.4 | mol % |
| 4-pentylcyclohexanecarboxylic acid 4-(5-decylpyrimidin- | 10.4 | mol % |
| 2-yl)-phenyl ester | | |
| 2-(4-hexyloxyphenyl)-5-octyloxypyrimidine | 9.5 | mol % |
| 5-octyloxy-2-(4-octyloxyphenyl)-pyrimidine | 8.8 | mol % |
| 2-(4-nonyloxyphenyl)-5-octyloxypyrimidine | 8.5 | mol % |
| 2-(4-dodecyloxyphenyl)-5-octyloxypyrimidine | 7.8 | mol % |
| 2-(4-decyloxyphenyl)-5-octyloxypyrimidine | 8.3 | mol % |
| 5-heptyl-2-(4-octyloxyphenyl)-pyrimidine | 9.5 | mol % |
| [10-(2″,3″-difluoro-4-heptyl-[1,1′;4′,1″]terphenyl- | 10 | mol % |
| 4″-yloxy)-decyl]-trimethylsilane | | |

Exhibits the following liquid crystalline properties:
Phase map: Cr −3.6 S_{C} 79.0 S_{A} 86.5 N 94.1 I; S_{C} −20.0 Cr
Viscosity at 0° C.: 459 millipascal seconds
Polarization at 0° C.: 38.4 nC/cm²

An example of the supercooling effect was seen in mixture MX20311, which is a 28 component mixture consisting of the following molar percentages of various types of components.

| | Approximate molar |
|---|---|
| Type of component | percentage in MX20311 |
| Phenylpyrimidine | 21 |
| Phenylpyridine | 37 |
| Fluorinated terphenyl | 15 |
| Cyclohexyl ester | 14 |
| Biphenylpyridine | 3 |
| Diphenylpyridine | 2 |
| Biphenylpyrimidine | 16 |
| Alkene tail | 4 |
| Partially perfluorinated tail | 13 |
| Chiral component | 18 |

The freezing point of MX20311 was determined, using a scanning differential calorimeter, to be approximately −27° C. However, when the material was placed in 0.7 micron cells and held for of approximately 264 hours at −30° C., no crystallization occurred. Similar treatment of the material in 0.7 micron cells for 11 days at −35° C. also resulted in no crystallization. MX 20311 contains 2.6 molar percent of 1976, shown below:

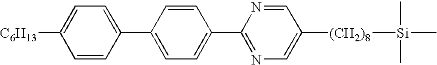

### 2-(4′-hexylbiphenyl-4-yl)-5-[6-(trimethylsilanyl)-octyl]-pyrimidine

Other similar mixtures lacking a component with a silylated tail did not show this supercooling effect, but instead showed large amounts of crystallization upon prolonged exposure to temperatures of −30 and −35° C.

When a group of substituents is disclosed herein, it is understood that all individual members of those groups and all subgroups, including any isomers and enantiomers of the group members, and classes of compounds that can be formed using the substituents are disclosed separately. When a compound is claimed, it should be understood that compounds known in the art including the compounds disclosed in the references disclosed herein are not intended to be included. When a Markush group or other grouping is used herein, all individual members of the group and all combinations and subcombinations possible of the group are intended to be individually included in the disclosure.

Every formulation or combination of components described or exemplified can be used to practice the invention, unless otherwise stated. Specific names of compounds are intended to be exemplary, as it is known that one of ordinary skill in the art can name the same compounds differently. When a compound is described herein such that a particular isomer or enantiomer of the compound is not specified, for example, in a formula or in a chemical name, that description is intended to include each isomers and enantiomer of the compound described individual or in any combination. One of ordinary skill in the art will appreciate that methods, device elements, starting materials, and synthetic methods other than those specifically exemplified can be employed in the practice of the invention without resort to undue experimentation. All art-known functional equivalents, of any such methods, device elements, starting materials, and synthetic methods intended to be included in this invention. Whenever a range is given in the specification, for example, a temperature range, a time range, or a composition range, all intermediate ranges and subranges, as well as all individual values included in the ranges given are intended to be included in the disclosure.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. Any recitation herein of the term “comprising”, particularly in a description of components of a composition or in a description of elements of a device, is understood to encompass those compositions and methods consisting essentially of and consisting of the recited components or elements. The invention illustratively described herein suitably may be practiced in the absence of any element or elements, limitation or limitations which is not specifically disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

In general the terms and phrases used herein have their art-recognized meaning, which can be found by reference to standard texts, journal references and contexts known to those skilled in the art. All patents and publications mentioned in the specification are indicative of the levels of skill of those skilled in the art to which the invention pertains.

One skilled in the art would readily appreciate that the present invention is well adapted to carry out the objects and obtain the ends and advantages mentioned, as well as those inherent therein. The compounds, compositions, methods and accessory methods described herein as presently representative of preferred embodiments are exemplary and are not intended as limitations on the scope of the invention. Changes therein and other uses will occur to those skilled in the art, which are encompassed within the spirit of the invention, are defined by the scope of the claims.

Although the description herein contains many specificities, these should not be construed as limiting the scope of the invention, but as merely providing illustrations of some of the embodiments of the invention. For example, cores, tails and substituents other than those specifically illustrated herein are included in the invention. Thus, additional embodiments are within the scope of the invention and within the following claims. All references cited herein are hereby incorporated by reference to the extent that there is no inconsistency with the disclosure of this specification. Some references provided herein are incorporated by reference herein to provide details concerning additional starting materials, additional methods of synthesis, additional methods of analysis and additional uses of the invention.

1. A liquid crystal composition comprising:
one or more liquid crystal compounds and one or more additive liquid crystalline compounds, wherein said composition can be supercooled.

2. The composition of claim 1, wherein the additive liquid crystalline compounds comprise one or more silyl-containing liquid crystalline compounds.

3. The composition of claim 2, wherein the one or more silyl-containing liquid crystalline compounds have the formula (I): 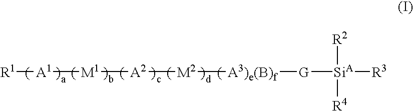
wherein:
R¹ is a straight-chain or branched alkyl or alkenyl group (with or without one or more asymmetrical carbon atoms) containing 2 to 16 carbon atoms, wherein one or two non-adjacent —CH2— groups may be substituted by —O—, —S—, —CO—O—, or —O—CO— and wherein one or more hydrogens may be replaced by fluorine;
A¹, A², A³ may be the same or different and are selected from the group consisting of: 1,4-phenylene, naphth-2,6-diyl, 1,4-dihydronaphth-2,6-diyl, 1,2,3,4-tetrahydronaphth-2,6-diyl, trans-1,4-cyclohexylene, 1,4-cyclohexyl, 1,2-cyclohexen-1,4-diyl, pyridine-2,5-diyl, pyrimidine-2,5-diyl, 1,3,4-thisdiazol-2,5-diyl, pyrazine-2,5-diyl, pyridizine-3,6-diyl, 1,3-dithiane-2,5-diyl, 1,3-dioxane-2,5-diyl, and thiophen-2,5-diyl, wherein independently in each of the groups A¹, A² and A³, one or two hydrogens may be replaced with fluorine or methyl;
M¹, M² may be the same or different and are selected from the group consisting of: —CO—O—, —O—CO—, —CH2—O—, —CH2—CH2—, —CH═CH—, —C≡C—, and —O—CH2—;
G is a straight-chain alkylene or alkenylene group containing 1 to 16 carbon atoms in which one or two nonadjacent —CH2— groups may be replaced by —O—, —CO—O—, or —O—CO—, with the proviso that Si^{A} is bound only to a carbon atom of G;
R²,R³,R⁴ may be the same or different and are straight-chain or branched-chain alkyl or alkenyl groups, or a cycloalkane or cycloalkene, containing 1 to 16 carbon atoms, in which one to three nonadjacent —CH2— groups may be replaced by —O—, —CO—O—, —O——CO—, —Si(Me2)—, with the proviso that the Si in —Si(Me2) is bound only to a carbon atom, and any or all of the hydrogen atoms on the carbons may be substituted with fluorines;
B is —O—, —S—, —CO—O—, or —O—CO—, —CO—, —S—CO—, —CO—S—, or a single bond; a, b, c, d, e, f=0 or 1, provided that a +c+e=1, 2 or 3.

4. The composition of claim 2, wherein the one or more silyl-containing liquid crystalline compounds comprise at least about 2 mole percent of the mixture.

5. The composition of claim 1, wherein the composition has lower viscosity than a composition that does not include an additive liquid crystalline compound.

6. The composition of claim 1, wherein the composition has higher smectic C stability than a composition that does not include an additive liquid crystalline compound.

7. A method of increasing the low temperature stability of a liquid crystal mixture, comprising adding one or more silyl-containing liquid crystalline compounds to a liquid crystal mixture.

8. The method of claim 7, wherein the silyl-containing liquid crystalline compounds are one or more of the compounds of formula (I). 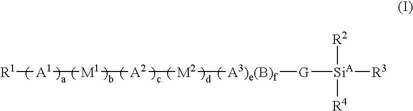
wherein:
R¹ is a straight-chain or branched alkyl or alkenyl group (with or without one or more asymmetrical carbon atoms) containing 2 to 16 carbon atoms, wherein one or two non-adjacent —CH2— groups may be substituted by —O—, —S—, —CO—O—, or —O—CO— and wherein one or more hydrogens may be replaced by fluorine;
A¹, A², A³ may be the same or different and are selected from the group consisting of: 1,4-phenylene, naphth-2,6-diyl, 1,4-dihydronaphth-2,6-diyl, 1,2,3,4-tetrahydronaphth-2,6-diyl, trans-1,4-cyclohexylene, 1,4-cyclohexyl, 1,2-cyclohexen-1,4-diyl, pyridine-2,5-diyl, pyrimidine-2,5-diyl, 1,3,4-thisdiazol-2,5-diyl, pyrazine-2,5-diyl, pyridizine-3,6-diyl, 1,3-dithiane-2,5-diyl, 1,3-dioxane-2,5-diyl, and thiophen-2,5-diyl, wherein independently in each of the groups A¹, A² and A³, one or two hydrogens may be replaced with fluorine or methyl;
M¹, M² may be the same or different and are selected from the group consisting of: —CO—O—, —O—CO—, —CH2—O—, —CH2—CH2—, —CH═CH—, —C≡C—, and —O—CH2—;
G is a straight-chain alkylene or alkenylene group containing 1 to 16 carbon atoms in which one or two nonadjacent —CH2— groups may be replaced by —O—, —CO—O—, or —O—CO—, with the proviso that Si^{A} is bound only to a carbon atom of G;
R², R³, R⁴ may be the same or different and are straight-chain or branched-chain alkyl or alkenyl groups, or a cycloalkane or cycloalkene, containing 1 to 16 carbon atoms, in which one to three nonadjacent —CH2— groups may be replaced by —O—, —CO—O—, —O—CO—, —Si(Me2)—, with the proviso that the Si in —Si(Me2)— is bound only to a carbon atom, and any or all of the hydrogen atoms on the carbons may be substituted with fluorines;
B is —O—, —S—, —CO—O—, or —O—CO—, —CO—, —S—CO—, —CO—S—, or a single bond; a, b, c, d, e, f=0 or 1, provided that a+c+e=1, 2 or 3.

9. The method of claim 7, wherein the silyl-containing liquid crystalline compound comprises at least about 2 mole percent of the mixture.

10. The method of claim 7, wherein the mixture can be supercooled.

11. A silyl-containing liquid crystalline compound of the general formula (I) 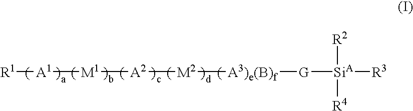
wherein:
R¹ is a straight-chain or branched alkyl or alkenyl group (with or without one or more asymmetrical carbon atoms) containing 2 to 16 carbon atoms, wherein one or two non-adjacent —CH2— groups may be substituted by —O—, —S—, —CO—O—, or —O—CO— and wherein one or more hydrogens may be replaced by fluorine;
A¹, A², A³ may be the same or different and are selected from the group consisting of: 1,4-phenylene, naphth-2,6-diyl, 1,4-dihydronaphth-2,6-diyl, 1,2,3,4-tetrahydronaphth-2,6-diyl, trans-1,4-cyclohexylene, 1,4-cyclohexyl, 1,2-cyclohexen-1,4-diyl, pyridine-2,5-diyl, pyrimidine-2,5-diyl, 1,3,4-thisdiazol-2,5-diyl, pyrazine-2,5-diyl, pyridizine-3,6-diyl, 1,3-dithiane-2,5-diyl, 1,3-dioxane-2,5-diyl, and thiophen-2,5-diyl, wherein independently in each of the groups A¹, A² and A³, one or two hydrogens may be replaced with fluorine or methyl;
M¹, M² may be the same or different and are selected from the group consisting of: —CO—O—, —O—CO—, —CH2—O—, —CH2—CH2—, —CH═CH—, —C_—C—, and —O—CH2—;
G is a straight-chain alkylene or alkenylene group containing 1 to 16 carbon atoms in which one or two nonadjacent —CH2— groups may be replaced by —O—, —CO—O—, or —O—CO—, with the proviso that Si^{A} is bound only to a carbon atom of G;
R², R³, R⁴ may be the same or different and are straight-chain or branched-chain alkyl or alkenyl groups, or a cycloalkane or cycloalkene, containing 1 to 16 carbon atoms, in which one to three nonadjacent —CH2— groups may be replaced by —O—, —CO—O—, —O—CO—, —Si(Me2)—, with the proviso that the Si in —Si(Me2)— is bound only to a carbon atom, and any or all of the hydrogen atoms on the carbons may be substituted with fluorines;
B is —O—, —S—, —CO—O—, or —O—CO—, —CO—, —S—CO—, —CO—S—, or a single bond;
a, b, c, d, e, f=0 or 1, provided that a+c+e=1, 2 or 3.

12. The compound of claim 11, wherein, in the general formula (I) the grouping
(-A¹)ₐ(-M¹)_{b}(-A²)C(-M²)_{d}(-A³)ₑ
is:

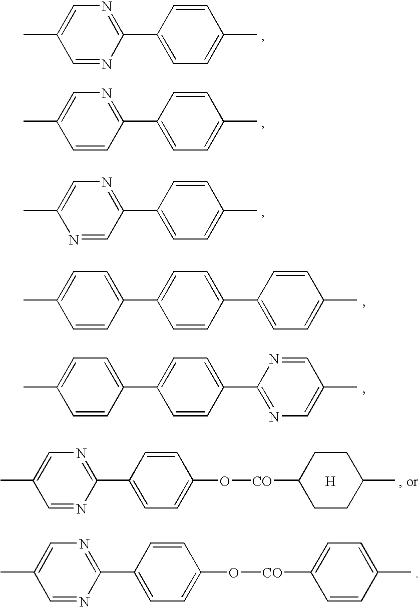

13. A liquid crystalline mixture comprising at least one silyl-containing liquid crystalline compound of the general formula (I): 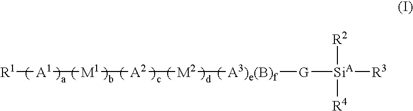
wherein:
R¹ is a straight-chain or branched alkyl or alkenyl group (with or without one or more asymmetrical carbon atoms) containing 2 to 16 carbon atoms, wherein one or two non-adjacent —CH2— groups may be substituted by —O—, —S—, —CO—O—, or —O—CO— and wherein one or more hydrogens may be replaced by fluorine;
A¹, A², A³ may be the same or different and are selected from the group consisting of: 1,4-phenylene, naphth-2,6-diyl, 1,4-dihydronaphth-2,6-diyl, 1,2,3,4-tetrahydronaphth-2,6-diyl, trans-1,4-cyclohexylene, 1,4-cyclohexyl, 1,2-cyclohexen-1,4-diyl, pyridine-2,5-diyl, pyrimidine-2,5-diyl, 1,3,4-thisdiazol-2,5-diyl, pyrazine-2,5-diyl, pyridizine-3,6-diyl, 1,3-dithiane-2,5-diyl, 1,3-dioxane-2,5-diyl, and thiophen-2,5-diyl, wherein independently in each of the groups A¹, A² and A³, one or two hydrogens may be replaced with fluorine or methyl;
M¹, M² may be the same or different and are selected from the group consisting of: —CO—O—, —O—CO—, —CH2—O—, —CH2—CH2—, —CH═CH—, —C_C—, and —O—CH2—;
G is a straight-chain alkylene or alkenylene group containing 1 to 16 carbon atoms in which one or two nonadjacent —CH2— groups may be replaced by —O—, —CO—O—, or —O—CO—, with the proviso that Si^{A} is bound only to a carbon atom of G;
R²,R³,R⁴ may be the same or different and are straight-chain or branched-chain alkyl or alkenyl groups, or a cycloalkane or cycloalkene, containing 1 to 16 carbon atoms, in which one to three nonadjacent —CH2— groups may be replaced by —O—, —CO—O—, —O—CO—, —Si(Me2)—, with the proviso that the Si in —Si(Me2)— is bound only to a carbon atom, and any or all of the hydrogen atoms on the carbons may be substituted with fluorines;
B is —O—, —S—, —CO—O—, or —O—CO—, —CO—, —S—CO—, —CO—S—, or a single bond;
a, b, c, d, e, f=0 or 1, provided that a+c+e=1, 2 or 3, and a liquid crystal host.

14. The liquid crystalline mixture of claim 13, wherein the silyl-containing liquid crystalline compound comprises at least about 2 mole percent of the mixture.

15. The liquid crystalline mixture of claim 13, wherein the mixture has increased low temperature stability than a mixture that does not include the silyl-containing liquid crystalline compound.

16. The liquid crystalline mixture of claim 13, wherein the mixture has lower viscosity than a mixture that does not include the silyl-containing liquid crystalline compound.

17. The liquid crystalline mixture of claim 13, wherein the mixture has higher smectic C stability than a mixture that does not include the silyl-containing liquid crystalline compound.

18. An electrooptical device comprising a liquid crystal mixture which comprises one or more silyl-containing liquid crystalline compounds.

19. The device of claim 18, wherein the silyl-containing liquid crystalline compounds comprise one or more of the compounds of formula (I): 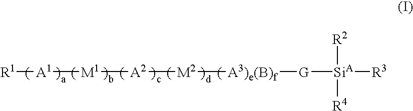
wherein:
R¹ is a straight-chain or branched alkyl or alkenyl group (with or without one or more asymmetrical carbon atoms) containing 2 to 16 carbon atoms, wherein one or two non-adjacent —CH2— groups may be substituted by —O—, —S—, —CO—O—, or —O—CO— and wherein one or more hydrogens may be replaced by fluorine;
A¹, A², A³ may be the same or different and are selected from the group consisting of: 1,4-phenylene, naphth-2,6-diyl, 1,4-dihydronaphth-2,6-diyl, 1,2,3,4-tetrahydronaphth-2,6-diyl, trans-1,4-cyclohexylene, 1,4-cyclohexyl, 1,2-cyclohexen-1,4-diyl, pyridine-2,5-diyl, pyrimidine-2,5-diyl, 1,3,4-thisdiazol-2,5-diyl, pyrazine-2,5-diyl, pyridizine-3,6-diyl, 1,3-dithiane-2,5-diyl, 1,3-dioxane-2,5-diyl, and thiophen-2,5-diyl, wherein independently in each of the groups A¹, A² and A³, one or two hydrogens may be replaced with fluorine or methyl;
M¹, M² may be the same or different and are selected from the group consisting of: —CO—O—, —O—CO—, —CH2—O—, —CH2—CH2—, —CH═CH—, —C≡C—, and —O—CH2—;
G is a straight-chain alkylene or alkenylene group containing 1 to 16 carbon atoms in which one or two nonadjacent —CH2— groups may be replaced by —O—, —CO—O—, or CO—, with the proviso that Si^{A} is bound only to a carbon atom of G;
R², R³, R⁴ may be the same or different and are straight-chain or branched-chain alkyl or alkenyl groups, or a cycloalkane or cycloalkene, containing 1 to 16 carbon atoms, in which one to three nonadjacent —CH2— groups may be replaced by —O—, —CO—O, —O——CO—, —Si(Me2)—, with the proviso that the Si in —Si(Me2)— is bound only to a carbon atom, and any or all of the hydrogen atoms on the carbons may be substituted with fluorines;
B is —O—, —S—, —CO—O—, or —O—CO—, —CO—, —S—CO—, —CO—S—, or a single bond;
a, b, c, d, e, f=0 or 1, provided that a+c+e=1, 2 or 3.

20. The device of claim 18, wherein the silyl-containing liquid crystalline compound comprises at least about 2 mole percent of the mixture.
